(19) United States
(12) Patent Application Publication
(10) Pub. No.: US 2010/0206089 A1
(43) Pub. Date: Aug. 19, 2010

(54) METHOD AND APPARATUS FOR TESTING POST-INSTALLED ANCHOR RODS

(76) Inventor: William A. Griswold, JR., Matthews, NC (US)

Correspondence Address: ADAMS INTELLECTUAL PROPERTY LAW, Suite 2350 Charlotte Plaza, 201 South College Street, CHARLOTTE, NC, 28244, US

(21) Appl. No.: 12/496,255

(22) Filed: Jul. 1, 2009

Related U.S. Application Data
(60) Provisional application No. 61/153,830, filed on Feb. 19, 2009.

(51) Int. Cl. G01N 3/08; E04G 21/12

(52) U.S. Cl. 73/826; 254/29 A

(57) ABSTRACT

A method is provided for testing a post installed anchor rod to determine the stresses on the anchor rod. The method comprises the steps of providing a linear hydraulic actuator comprising a cylinder, a piston slideable therein in response to a change in hydraulic pressure, and a longitudinal opening formed in the piston for receiving the anchor rod, positioning the anchor rod in the opening, releasably securing a fastener onto the anchor rod to a position in contact with the piston, actuating the linear hydraulic actuator to induce a force on the fastener and thereby a tensional stress on the anchor rod, and measuring elongation of the anchor rod resulting from the tensional stress.

### PRIORITY CLAIM

This application claims priority to provisional patent application No. 61/153,830 filed on Feb. 19, 2009.

### TECHNICAL FIELD AND BACKGROUND OF THE INVENTION

This application is directed towards a method and apparatus for testing post-installed anchor rods for towers and similar structures, and more particularly, towards a method for testing a post-installed anchor rod by subjecting the anchor rod to tensile stresses produced by a hydraulic cylinder in communication with the anchor rod.

Towers, such as water towers, cellular phone towers, and other structures, such as damns, bridges, roads, and general construction projects, are typically installed by drilling a plurality of anchor rods through a base of the structure and coreing into the underlying foundation. These bolts are typically arranged around the perimeter of the structure. For example, for cylindrical shaped towers, the anchor rods are positioned in a circular pattern about the structure. Typically, a series of closely-spaced apart bolts are placed in a first series around the structure and are set to depths of up to ten feet into the foundation. A plurality of further-spaced apart anchor rods are then positioned around the closely-spaced apart bolts and may be cored into the existing foundation. The anchor rods may be further secured by an epoxy or other bonding agent that acts to stabilize and maintain the anchor rods into the foundation and concrete is typically poured around the anchor rods.

Testing by anchor rods in a post-installed state can be difficult because of the close spacing of adjacent anchor rods and the close spacing between anchor rods and an adjacent structure such as the lower leg or legs.

Accordingly, a need exists for performing in-place testing of anchor rods used for securing a structure to a foundation. A need also exists for performing in-place testing of anchor rods that allows the anchor rod to be in its typically installed position during testing. Finally, a need exists for performing in-place testing of anchor rods that can be performed quickly and in a time and cost efficient manner.

### SUMMARY OF THE INVENTION

It is an object of the invention to provide an in-place method for testing post-installed anchor rods.

It is a further object of the invention to provide an in-place apparatus for testing post-installed anchor rods.

It is a further object of the invention to provide an in-place apparatus for testing post-installed anchor rods in a quick and time efficient manner.

These and other objects and advantages of the present invention are achieved in the preferred embodiments set forth below by providing a method for testing a post installed anchor rod to determine the stresses on the anchor rod. The method includes the steps of providing a linear hydraulic actuator comprising a cylinder, a piston slideable therein in response to a change in hydraulic pressure, and a longitudinal opening formed in the piston for receiving the anchor rod, positioning the anchor rod in the opening, releasably securing a fastener onto the anchor rod to a position in contact with the piston, actuating the linear hydraulic actuator to induce a force on the fastener and thereby a tensional stress on the anchor rod, and measuring elongation of the anchor rod resulting from the tensional stress.

According to another embodiment of the invention, the method further includes the steps of, before the step of releasably securing a fastener onto the anchor rod, providing a bridging member comprising a sleeve for engaging the anchor rod and an extension portion for extending the anchor rod, and securing the sleeve onto the anchor rod.

According to another embodiment of the invention, the method further includes comprising the steps of, wherein in the step of actuating the linear hydraulic actuator, the linear hydraulic actuator is actuated in progressively larger force amounts up to a target amount, and elongation of the anchor rod is measured at each progressively larger force amount.

According to another embodiment of the invention, the target amount is about 1.33 times the design load.

According to another embodiment of the invention, the method further includes the step of deactuating the linear hydraulic actuator and measuring elongation of the anchor rod resulting from the tensional stress.

According to another embodiment of the invention, wherein in the step of deactuating the linear hydraulic actuator, the linear hydraulic actuator is deactuated in progressively smaller force amounts, and elongation of the anchor rod is measured at each progressively smaller force amount.

According to another embodiment of the invention, the method further includes the steps of positioning a subsequent anchor rod in the opening, releasably securing a fastener onto the subsequent anchor rod to a position in contact with the piston, actuating the linear hydraulic actuator to induce a force on the fastener and thereby a tensional stress on the subsequent anchor rod, and measuring elongation of the subsequent anchor rod resulting from the tensional stress.

According to another embodiment of the invention, the anchor rod having the northernmost position is tested first.

According to another embodiment of the invention, the linear hydraulic actuator is actuated by a pneumatic pump.

According to another embodiment of the invention, the anchor rod is threaded ant the fastener is a threaded reaction nut.

According to another embodiment of the invention, wherein in the step of measuring elongation of the anchor rod resulting from the tensional stress, a dial indicator is provided and positioned proximal to the anchor rod for measuring elongation of the anchor rod.

According to another preferred embodiment of the invention, a linear hydraulic actuator for testing post-installed anchor rods is provided. The linear hydraulic actuator includes a cylinder, a piston slideable therein in response to a change in hydraulic pressure and defining a top surface for mating with a releasable fastener for securing an anchor rod, and a longitudinal opening formed in the piston for receiving the anchor rod.

According to another embodiment of the invention, the linear hydraulic actuator further includes a lock collar positioned at one end of the cylinder for restricting slideable movement of the piston beyond a predetermined point.

According to another embodiment of the invention, the linear hydraulic actuator further includes a hydraulic pressure source in fluid communication with the linear hydraulic actuator.

According to another embodiment of the invention, the linear hydraulic actuator further includes a bridging member having a sleeve for engaging the anchor rod and an extension portion for extending the anchor rod, wherein the extension member mates with the linear hydraulic actuator.

According to another embodiment of the invention, the linear hydraulic actuator further includes a dial indicator positioned in proximity to the linear hydraulic actuator and configured to measure elongation of the anchor rod.

### BRIEF DESCRIPTION OF THE DRAWINGS

The invention may be best understood by reference to the following description in conjunction with the accompanying drawing figures in which:

FIG. 1 is a side underground view of a structure installed into a foundation;

FIG. 2 is an overhead view of a base of the structure shown in FIG. 1;

FIG. 3 is a perspective view of the linear hydraulic actuator according to the present invention;

FIG. 4 is a side cross sectional view of the linear hydraulic actuator shown in FIG. 4;

FIG. 5 is a side cross sectional view of the linear hydraulic actuator further including a bridge member for axially extending the linear hydraulic actuator about an anchor rod;

FIG. 6 is a perspective view of the linear hydraulic actuator shown in FIG. 5;

FIG. 7 is a perspective view of the linear hydraulic actuator installed on an anchor rod according to the present invention;

FIG. 8 is a perspective view of the linear hydraulic actuator installed about an anchor rod according to the present invention;

FIG. 9 is a perspective view of a measuring device holder according to the present invention;

FIG. 10 is a perspective view of a pump for imparting fluid pressure on the linear hydraulic actuator according to the present invention; [[and]]

FIG. 11 is a perspective view of the linear hydraulic actuator is an uninstalled state.

### DESCRIPTION OF THE PREFERRED EMBODIMENT AND BEST MODE

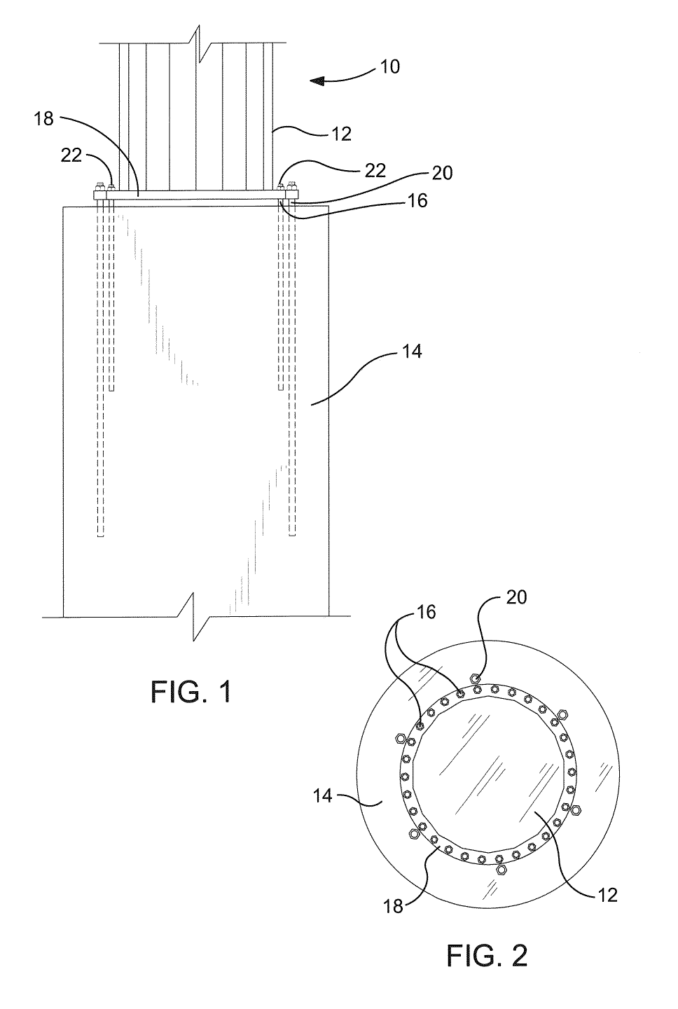

Referring now specifically to the drawings, a structure 10 is secured to a nearby foundation 14 according to the current state of the art as is illustrated in FIGS. 1 and 2. The structure 10 includes a major portion 12 and a structure base 18 and is secured to the foundation 14 by a plurality of closely-spaced apart inner anchor rods 16 that are driven through the base 18 of the structure 14. A plurality of further-spaced outer anchor rods 20 are positioned around the perimeter of the closely-spaced inner anchor rods 16. Each anchor rod, 16 and 20, is secured to the base 18 by at least one anchor nut 22, and preferably, at least two anchor nuts 22 are double nutted against one another for increased strength and resistance to loosening. As shown in FIG. 2, each inner anchor rod 16 is closely-spaced to a subsequent inner anchor rod 16, whereas each outer anchor rod 20 is generally further-spaced apart to each subsequent outer anchor rod 20, but generally closely-spaced to each inner anchor rod 16. In the structure shown in FIGS. 1 and 2, the structure 10 is a generally cylindrical structure, but it is appreciated that varying sizes, shapes, and applications of structures are used, and the present invention can be equally applied to all such structures.

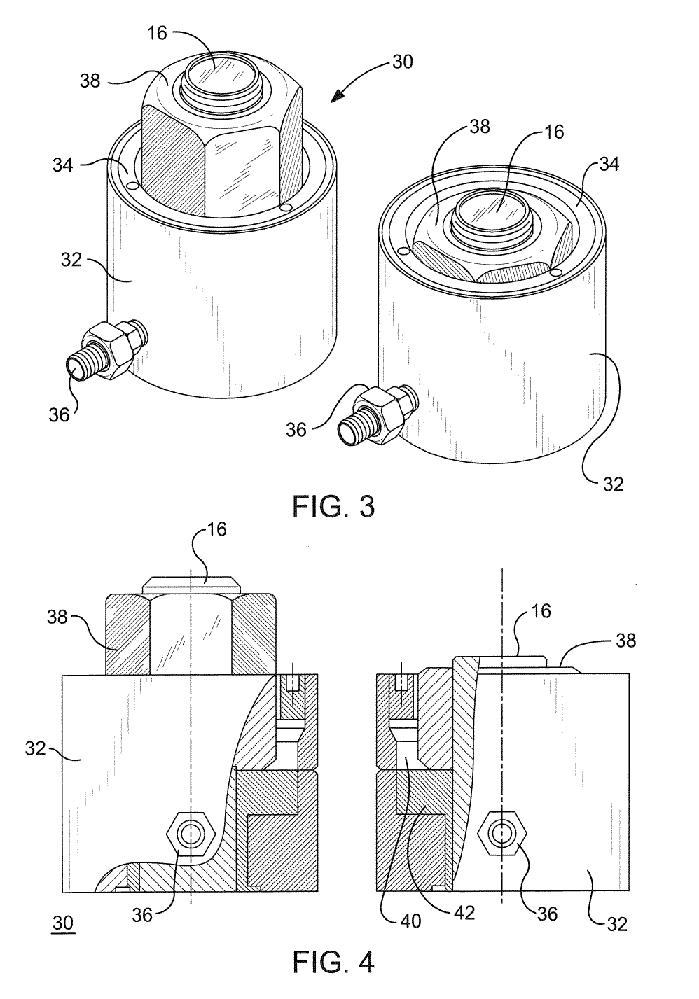

A linear hydraulic actuator according to the present invention is shown in FIGS. 3-6 and is generally designated 30. The linear hydraulic actuator 30 is adapted to fit around an anchor rod 16 or anchor rod 20 of a structure 10 as described in regards to the description of FIGS. 1 and 2. The linear hydraulic actuator 30 includes a cylinder jug 32 that defines a cylinder 40 within the cylinder jug 32. A hydraulic piston 42 is adapted to be received within the cylinder 40 and collectively forms a hydraulic pump. A fluid connector 36 is in communication with the cylinder 40 and is adapted to receive pressure input to vary the hydraulic pressure within the cylinder 40. A stop collar 34 is placed at the most vertical position of the cylinder 30 and acts to restrict movement of the hydraulic piston 42 beyond a predetermined position.

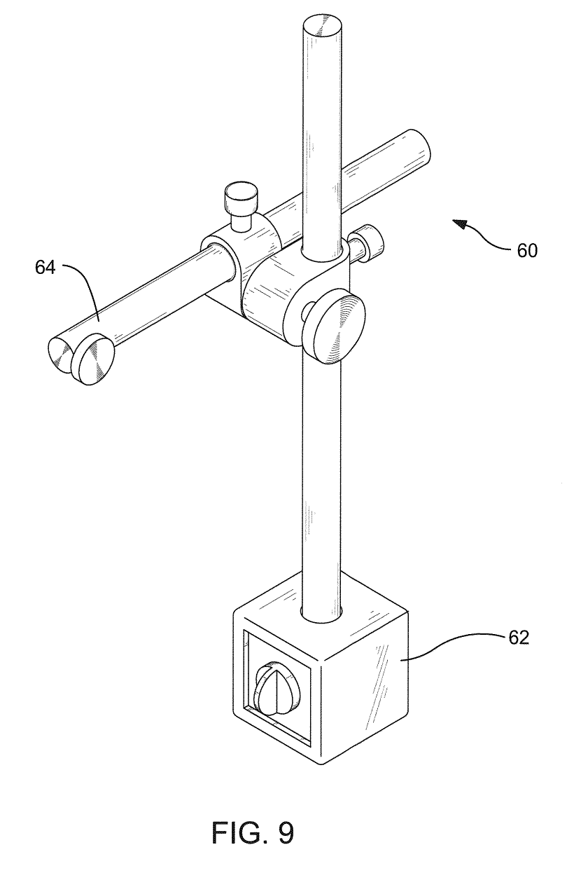

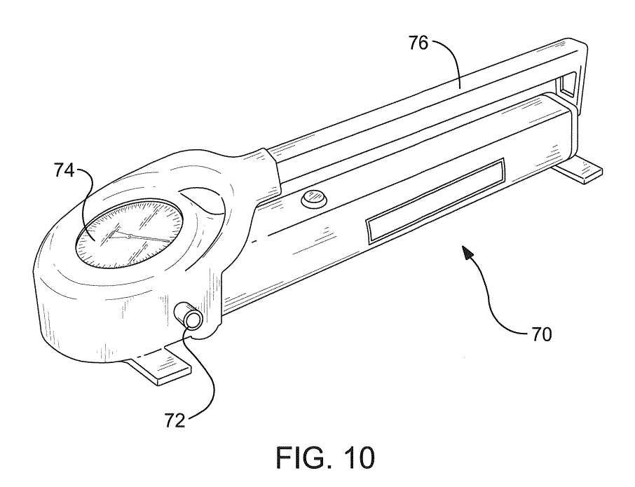

A fastener, such as reaction nut 38, is rotatably threaded onto the anchor rod 16. Reaction nut 38 can be the anchor nut 22 if desired, and may also be double-nutted, if desired. As shown in FIG. 4, the reaction nut 38 has been tighten against the hydraulic piston forming a sufficiently tight interconnection. A plurality of shims 39, as shown in FIG. 9, may be provided underneath the linear hydraulic actuator 30 to fit against base 18 and elevate the linear hydraulic actuator 32 to a desired height, and will have a shape to preferably match a base of the linear hydraulic actuator 30.

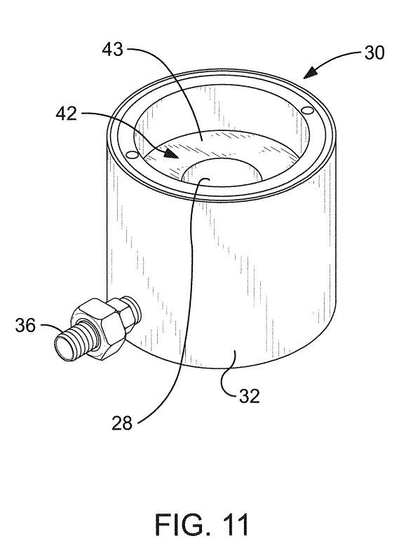

As shown in FIG. 11, the linear hydraulic actuator 30 defines an opening 28 for receiving an anchor rod 16 or 20. The piston 42 defines an upper mating surface 43 for mating against reaction nut 38. The linear hydraulic actuator 30 is sized such that standard size anchor rods 16, 20 may fit within opening 28, and that standard size reaction nuts 38 will fit on mating surface 43.

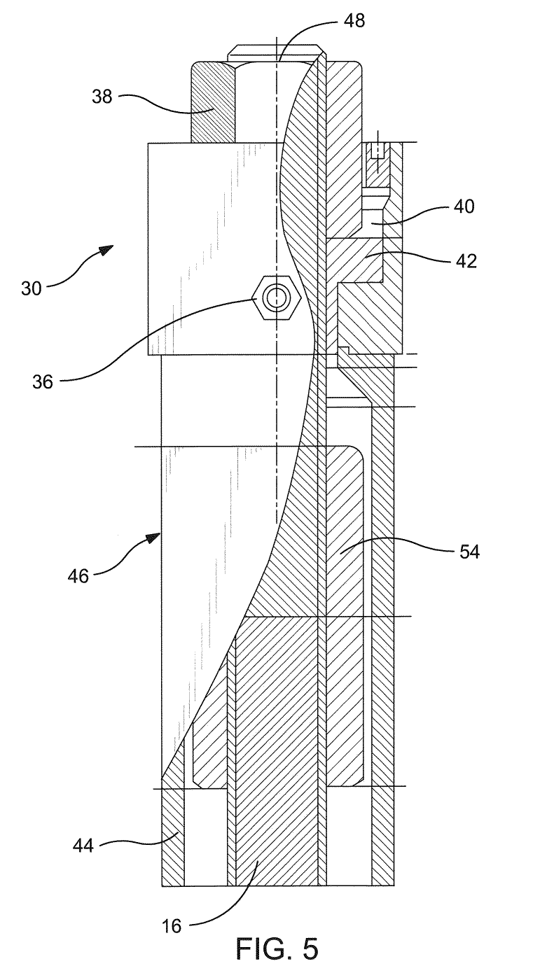

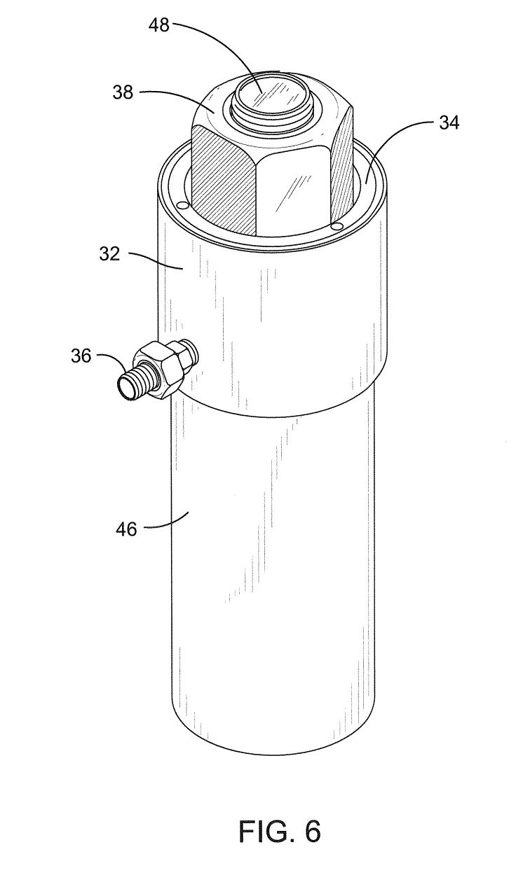

As shown in FIGS. 5 and 6, the linear hydraulic actuator 30 may include a bridge member 46 that is adapted to alter the height of the linear hydraulic actuator 30 about anchor rod 16 or anchor rod 20. In this instance, the bridge member 46 includes an extension stud 48 that is connected with the bridge member 46. In some instances, it may be preferable to elevate the linear hydraulic actuator 30 about the anchor rod 16 so that the reaction nut 38 does not have to be threaded down the anchor rod 16 as far, or due to size constraints. The bridge member 46 includes a bridge wall 44 that defines a cavity therein, and a coupler 54 for coupling the extension stud 48 to the anchor fastener 16. The coupler 54 may be configured for threadably engaging anchor rod 16.

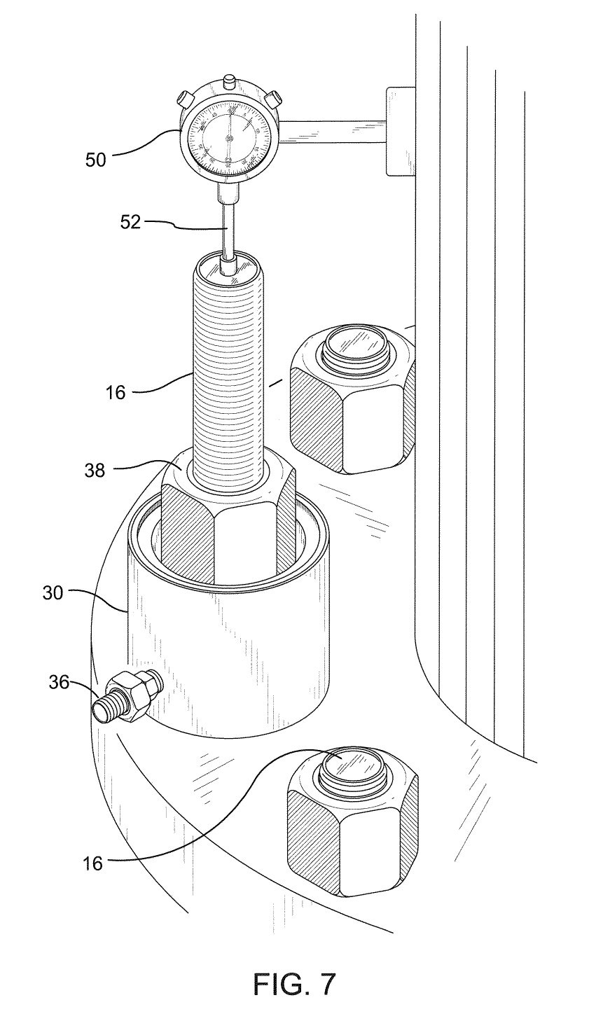

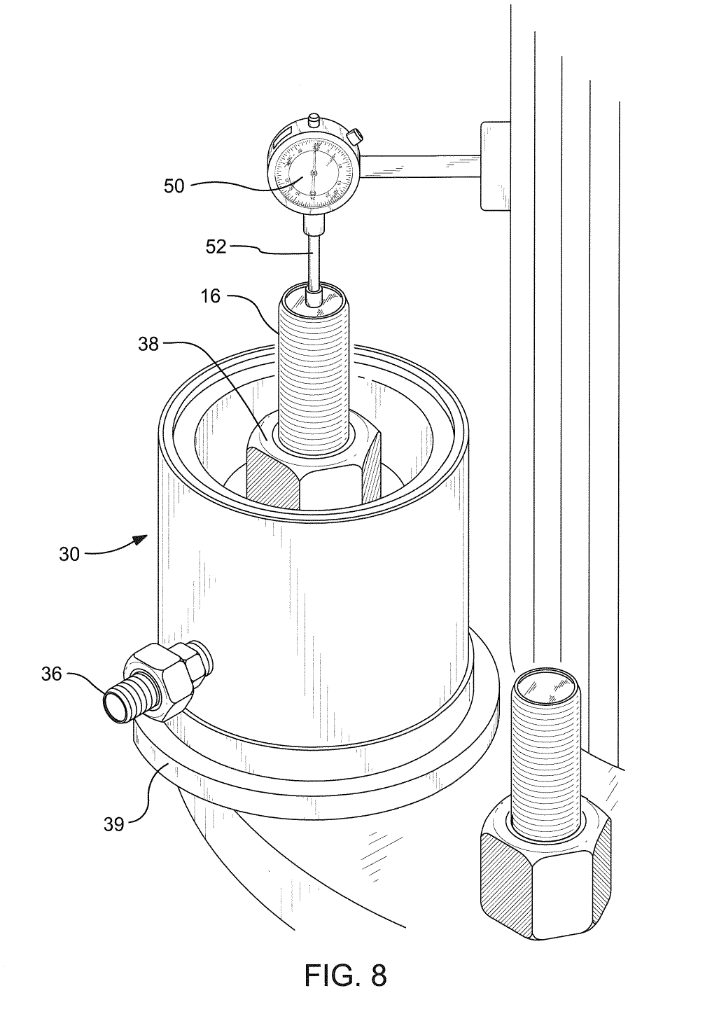

The linear hydraulic actuator 30 is shown in an installed state according to FIGS. 7 and 8. Operation of the linear hydraulic actuator 30 will be described in greater detail in subsequent paragraphs of this application. A measuring device, preferably a dial indicator 50, is provided proximal the anchor rod 16 and is generally used to measure the deflection of a portion of the anchor rod 16. The dial indicator 50 includes a travel indicating shaft 52. The travel indicating shaft 52 is designed to receive linear movement of a proximal object and impart that movement to a mechanical process that will then be output on the dial indicator 50 as a measure of distance traveled.

As shown in FIG. 9, a measuring device holder 60 is provided for positioning the dial indicator 50 above the anchor rod 16. The measuring device holder 60 includes a magnetic base 62 for attaching to the structure base 18, which is generally made of a ferrous material, or to any nearby ferrous structure. The measuring device holder 60 includes a holding member 64 adapted to hold the dial indicator 50. The measuring device holder 60 has a plurality of extending members which may be rotatably connected and extendable or retractable so that the dial indicator 50 may be positioned in the appropriate place, preferably vertically above the anchor rod 16 or extension stud 48. Other suitable means for fastening the measuring device holder 60 to the structure will be readily appreciated by those skilled in the art.

As shown in FIG. 10, a pump 70 is provided and is in fluid communication to the linear hydraulic actuator via fluid connector 72. The pump 70 is connected by an appropriate fluid line to fluid connector 36 of the linear hydraulic actuator 30, thereby providing fluid communication between the pump 70 and the linear hydraulic actuator 30. The pump 70 includes a mechanical lever 76 that provides a mechanical advantage to the pump 70 so that an operator can easily provide pumping pressure to the linear hydraulic actuator 30. A gauge 72 is provided on the pump 70 for determining the pumping pressure.

An anchor rod test report generator spreadsheet may be provided on a personal computer for inputting elongation amounts as determined by the dial indicator 50 in relation to the force within the linear hydraulic actuator 30. This spreadsheet may be suitably programmed within any spreadsheet program including Microsoft Excel© and will generally include variables such as force, elongation, elongation/force, or force/elongation, and may optionally include testing variables such as the location of the structure, access requirements, point of contact, report addressee, diameter of the anchor rod 16, material, projection above base 18, and thread type of the anchor rods 16. Other variables may include distance from the center line of the anchor rod 16 to the structure 10, to the edge of base 18, and to adjacent anchor rods, stiffeners, or other obstructions.

Installation and use of the invention will now be described according to the best mode requirements. The operator shall designate the most northern anchor rod 16 or 20 as the first anchor rod to be tested. Additional rods to be tested are numbered in a clockwise order. The operator should then clean debris around the anchor rod to be tested 16 or 20 to assure the base of the linear hydraulic actuator 30 rests flat on the structure base 18. In some circumstances, if no grout is present under the base plate, then the operator may install shims 39 under the linear hydraulic actuator 30 and base 18 or under the base 18. The maximum remaining gap under the base plate following installation of the shims 39 shall be no more than 1/16″. The operator should check that the anchor rod projection is below minimum acceptable install heights, and install appropriate bridge washer(s) over anchor rod 16 or 20.

If necessary, the operator may then connect the bridge 46 to the anchor rod 16 by centering the bridge 46 over the anchor rod 16 and rotating the bridge 46 so that coupler 54 threads onto anchor rod 16. Next, the operator should place the linear hydraulic actuator 30 over the anchor rod 16 and atop bridge 46 if required. The hydraulic hose from the hand pump 70 is then connected to the fluid connector 36 of the linear hydraulic actuator 30. The reaction nut 38 is then threaded onto the anchor rod 16, 20 or to extension stud 48 and tightened until it contacts the piston 42. This should be done without applying unnecessary force. A return-to-tank valve is provided on the hand pump 70 and should be closed.

The operator should then place the measuring device holder 60 on a side of the structure 10 or another suitable stationary surface. The dial indicator 50 is then attached vertically directly above the center of the anchor rod 16 or 20 or extension stud 48. The dial indicator 50 should be positioned such as to allow maximum upward movement of the anchor rod 16 or 20 or extension stud 48.

The operator should then determine the target or test load of the anchor rod 16 or 20 to be tested. This load can also be calculated as the Tension Area of the Anchor rod×The Material Yield Strength×0.8. This load is typically 133 percent of the design load. The operator should then verify that the correct anchor rod material or type and anchor rod size has been input into the anchor rod test report generator spreadsheet.

The operator will then apply pressure sufficient to develop an initial load of 5 percent of the target load and record the pressure. Set the dial indicator 50 to zero and record the time. Verify that the pressure on gage 74 is within plus or minus two percent. The operator should then wait a period of time, preferably two minutes, and record the pressure, the deflection reading on the dial indicator 50, and the time. Next, apply pressure sufficient to develop a load of 20 percent of the target load, record the pressure, the deflection reading on the dial indicator 50, and the time. The operator will then wait two minutes and record the pressure, the deflection reading on the dial indicator 50, and the time. The previous steps are then repeated with a pressure increase of 15 percent for each repetition to a pressure of 95 percent of the target load. This will typically yield pressures of 35 percent, 50 percent, 65 percent, 80 percent and 95 percent but may be varied depending on preferences. Then the operator will apply pressure sufficient to develop a load of 100 percent of the target load, record the pressure, the reading on the dial indicator, and the time. Also, the operator will verify that the pressure on gage 74 is within ±two percent. The operator then holds the pressure for two minutes and records the pressure, reading on the dial indicator 50, and the time. The return-to-tank valve on the hand pump is slowly opened to release the pressure on the system until the pressure drops to five percent of the target load. The pressure and the reading on the dial indicator 50 is then recorded. The return-to-tank valve is then opened to release all pressure in the system. The reaction nut 38 is then tightened to assure the hydraulic piston is fully retracted, and is then removed, along with the linear hydraulic actuator 30, bridge 46, any washers, extender stud 48, and coupler 54.

After testing, two primary types of failure might be expected as a result of this testing, “Displacement” and “Concrete Cracking.” Displacement can be either pullout of the anchor rod 16 or 20, or displacement failure as evidenced by continuous displacement of the anchor rod 16 or 20 with application of a constant or decreasing load. Some anchorage systems require an initial deformation to become effective. These types of anchorages may require a second test as the initial load application may be required to permanently seat the anchor. Preferably the maximum allowable displacement (after seating occurs is applicable) is 0.01 inches. This is measured as the difference between the displacement of the anchor rod 16 or 20 at 5 percent of the target load measured before and after the testing procedure. Concrete cracking can occur either as a shear-cone type failure, or cracking that radiates outward from the anchor rod 16.

All project setup data and test data is to be input into the anchor rod test report generator spreadsheet in accordance with the best mode described above. The spreadsheet may be configured to display a fail signal such as an “F”, “Fail”, or a red box when displacement reaches above a predetermined amount. In this manner, the spreadsheet may state either “PASSES” or “FAILS” for each anchor rod test based on the final deflection measurement under a load equal to 5 percent of the design load. However, if the anchor rod test causes failure by concrete cracking, and the displacement is less than 0.01 inches, then an F must be put into a “Test Failure Override Box” on the spreadsheet to cause a “FAILS” status to appear in the “Pass/Fail” chart at the bottom of the spreadsheet or any printout. A final report is to be written to a PDF file and that PDF file distributed to the client.

The best mode of the present invention is capable of testing anchor rods up to 2¼ inches in diameter. The test equipment preferably has the ability to apply a maximum load of 239,000 lbs. The required clearance around the linear hydraulic actuator is only 2 9/16 of an inch from the centerline of the anchor rod to be tested.

An apparatus and method for testing post-installed anchor rods is described above. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims.

We claim:

1. A method for testing a post installed anchor rod to determine the stresses on the anchor rod, comprising the steps of:
(a) providing a linear hydraulic actuator comprising a cylinder, a piston slideable therein in response to a change in hydraulic pressure, and a longitudinal opening formed in the piston for receiving the anchor rod;
(b) positioning the anchor rod in the opening;
(c) releasably securing a fastener onto the anchor rod to a position in contact with the piston;
(d) actuating the linear hydraulic actuator to induce a force on the fastener and thereby a tensional stress on the anchor rod; and
(e) measuring elongation of the anchor rod resulting from the tensional stress.

2. The method according to claim 1, further comprising the steps of:
(a) before the step of releasably securing a fastener onto the anchor rod, providing a bridging member comprising a sleeve for engaging the anchor rod and an extension portion for extending the anchor rod; and
(b) securing the sleeve onto the anchor rod.

3. The method according to claim 1, further comprising the steps of:
(a) wherein in the step of actuating the linear hydraulic actuator, the linear hydraulic actuator is actuated in progressively larger force amounts up to a target amount; and
(b) elongation of the anchor rod is measured at each progressively larger force amount.

4. The method according to claim 1, wherein the target amount is about 1.33 times the design load.

5. The method according to claim 1, further comprising the step of deactuating the linear hydraulic actuator and measuring elongation of the anchor rod resulting from the tensional stress.

6. The method according to claim 5, wherein in the step of deactuating the linear hydraulic actuator, the linear hydraulic actuator is deactuated in progressively smaller force amounts, and elongation of the anchor rod is measured at each progressively smaller force amount.

7. The method according to claim 1, further comprising the steps of:
(a) positioning a subsequent anchor rod in the opening;
(b) releasably securing a fastener onto the subsequent anchor rod to a position in contact with the piston;
(c) actuating the linear hydraulic actuator to induce a force on the fastener and thereby a tensional stress on the subsequent anchor rod; and
(d) measuring elongation of the subsequent anchor rod resulting from the tensional stress.

8. The method according to claim 7, wherein the anchor rod having the northernmost position is tested first.

9. The method according to claim 1, wherein the linear hydraulic actuator is actuated by a pneumatic pump.

10. The method according to claim 1, wherein the anchor rod is threaded ant the fastener is a threaded reaction nut.

11. The method according to claim 1, wherein in the step of measuring elongation of the anchor rod resulting from the tensional stress, a dial indicator is provided and positioned proximal to the anchor rod for measuring elongation of the anchor rod.

12. A linear hydraulic actuator for testing post-installed anchor rods, comprising:
(a) a cylinder;
(b) a piston slideable therein in response to a change in hydraulic pressure and defining a top surface for mating with a releasable fastener for securing an anchor rod; and
(c) a longitudinal opening formed in the piston for receiving the anchor rod.

13. The linear hydraulic actuator according to claim 12, further comprising a lock collar positioned at one end of the cylinder for restricting slideable movement of the piston beyond a predetermined point.

14. The linear hydraulic actuator according to claim 12, further comprising a hydraulic pressure source in fluid communication with the linear hydraulic actuator.

15. The linear hydraulic actuator according to claim 12, further comprising a bridging member having a sleeve for engaging the anchor rod and an extension portion for extending the anchor rod, wherein the extension member mates with the linear hydraulic actuator.

16. The linear hydraulic actuator according to claim 12, further including a dial indicator positioned in proximity to the linear hydraulic actuator and configured to measure elongation of the anchor rod.
